(19) United States
(12) Patent Application Publication
(10) Pub. No.: US 2025/0103276 A1
(43) Pub. Date: Mar. 27, 2025

(54) BROADCAST TECHNIQUES FOR MULTI-CHANNEL HOME THEATER

(71) Applicant: Sonos, Inc., Goleta, CA (US)

(72) Inventors: Timothy Andrew Reilly, Louisville, KY (US); Benjamin Andon Herr, Harrodsburg, KY (US)

(21) Appl. No.: 18/899,392

(22) Filed: Sep. 27, 2024

Related U.S. Application Data
(60) Provisional application No. 63/585,759, filed on Sep. 27, 2023.
(60) Provisional application No. 63/585,773, filed on Sep. 27, 2023.

(51) Int. Cl. G06F 3/16; H04R 5/04

(52) U.S. Cl. CPC G06F 3/165; H04R 5/04; H04R 2420/07

(57) ABSTRACT

In an example, a playback device includes a wireless communication interface, a processor, and a tangible non-transitory computer readable medium storing program instructions that are executable by the processor to cause the playback device to operate in a bonded group. Operating the playback device may include receiving a first audio stream including multi-channel audio content digitally encoded in a plurality of packets, each packet including a first number of symbols of each of a plurality of audio channels of the multi-channel audio content, for each packet, producing a set of interleaved packets of the multi-channel audio content, each interleaved packet of the set including a proper subset of the first number of symbols, producing a second audio stream including a plurality of the sets of interleaved packets, and broadcasting the second audio stream to a plurality of satellite playback devices in the bonded group via the wireless communication interface.

### CROSS-REFERENCE TO RELATED APPLICATIONS

This application claims priority to co-pending U.S. Provisional Application No. 63/585,759 titled “FRAME INTERLEAVING OF BROADCAST PACKETS FOR MULTI-CHANNEL HOME THEATER” and filed on Sep. 27, 2023, and to co-pending U.S. Provisional Application No. 63/585,773 titled “FRAME INTERPOLATION OF BROADCAST PACKETS FOR MULTI-CHANNEL HOME THEATER” and filed on Sep. 27, 2023, each of which is hereby incorporated herein by reference in its entirety.

### FIELD OF THE DISCLOSURE

The present disclosure is related to consumer goods and, more particularly, to methods, systems, products, aspects, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### SUMMARY

Aspects and examples relate to techniques for transmitting and receiving audio data in a media playback system.

According to one example, a playback device comprises a wireless communication interface configured to support communication of data via at least one network protocol, at least one processor, and at least one tangible non-transitory computer readable medium storing program instructions that are executable by the at least one processor to cause the playback device to operate in a bonded group comprising the playback device and a plurality of satellite playback devices. In an example, to operate in the bonded group comprises to receive a first audio stream including multi-channel audio content digitally encoded in a plurality of packets, each packet of the plurality including a first number of symbols of each of a plurality of audio channels of the multi-channel audio content, for each packet, produce a set of interleaved packets of the multi-channel audio content, each interleaved packet of the set including a proper subset of the first number of symbols, wherein a second number of symbols in the proper subset corresponds to the first number divided by a third number of interleaved packets in the set, produce a second audio stream comprising a plurality of the sets of interleaved packets of the multi-channel audio content, and broadcast the second audio stream to the plurality of satellite playback devices via the wireless communication interface.

According to another example, a playback device comprises a wireless communication interface configured to support communication of data via at least one network protocol, at least one processor, and at least one tangible non-transitory computer readable medium storing program instructions that are executable by the at least one processor to cause the playback device to operate in a bonded group comprising the playback device and a plurality of satellite playback devices. In an example, to operate in the bonded group comprises to divide a sample of multi-channel audio content into a plurality of frames of audio data, each frame of audio data comprising a first number of symbols of each audio channel of a plurality of audio channels of the multi-channel audio content, decompose each frame of audio data into a number of interleaved packets according to a modulo(k) approach applied to the first number of symbols, wherein k is the number of interleaved packets, produce an audio stream comprising the interleaved packets corresponding to one or more frames of the plurality of frames of audio data, and broadcast the audio stream to the plurality of satellite playback devices via the wireless communication interface.

According to another example, a playback device comprises one or more speakers, one or more amplifiers configured to drive the one or more speakers, an audio sample buffer, a wireless communication interface configured to support communication of data via at least one network protocol, and at least one processor. In an example, the playback device further comprises and at least one tangible non-transitory computer readable medium storing program instructions that are executable by the at least one processor to cause the playback device to receive, via the wireless communication interface, an audio stream comprising one or more frames of audio data corresponding to multi-channel audio content, each frame including a plurality of interleaved packets of the audio data, store at least one frame of audio data in the audio sample buffer, for each stored frame of audio data, de-interleave the plurality of interleaved packets to construct one or more channels of the multi-channel audio content, and render, via the one or more speakers and the one or more amplifiers, the one or more channels of the multi-channel audio content.

According to another example, a playback device comprises one or more speakers, one or more amplifiers configured to drive the one or more speakers, an audio sample buffer, a wireless communication interface configured to support communication of data via at least one network protocol, and at least one processor. In an example, the playback device further comprises at least one tangible non-transitory computer readable medium storing program instructions that are executable by the at least one processor to cause the playback device to receive, via the wireless communication interface, a first plurality of frames of audio data corresponding to multi-channel audio content, store the first plurality of frames of the audio data in the audio sample buffer, receive, via the wireless communication interface, a second plurality of frames of the audio data, store the second plurality of frames of the audio data in the audio sample buffer, determine that a particular frame of the audio data is missing from the second plurality of frames of the audio data, interpolate a representation of the missing frame based on a corresponding particular frame of the audio data in the first plurality of frames of the audio data, construct one or more channels of the multi-channel audio content based on the second plurality of frames of the audio data and the representation of the missing frame, and render, via the one or more speakers and the one or more amplifiers, the one or more channels of the multi-channel audio content.

According to another example, a playback device comprises a wireless communication interface configured to support communication of data via at least one network protocol, at least one processor, and at least one tangible non-transitory computer readable medium storing program instructions that are executable by the at least one processor to cause the playback device to operate in a bonded group comprising the playback device and a plurality of satellite playback devices. In an example, to operate in the bonded group comprises to construct a transmit audio stream comprising a first plurality of sequential frames of multi-channel audio content and a second plurality of sequential frames of the multi-channel audio content, the second plurality of sequential frames of the multi-channel audio content being time-delayed by one frame relative to the first plurality of sequential frames of the multi-channel audio content, and broadcast the transmit audio stream to the plurality of satellite playback devices via the wireless communication interface.

Another example is directed to a method of generating audio with a playback device. In an example, the method comprises receiving, at the playback device, a first plurality of frames of audio data corresponding to multi-channel audio content, storing the first plurality of frames of the audio data in an audio sample buffer of the playback device, receiving, at the playback device, a second plurality of frames of the audio data, storing the second plurality of frames of the audio data in the audio sample buffer, determining that a particular frame of the audio data is missing from the second plurality of frames of the audio data, interpolating a representation of the missing frame based on a corresponding particular frame of the audio data in the first plurality of frames of the audio data, constructing one or more channels of the multi-channel audio content based on the second plurality of frames of the audio data and the representation of the missing frame, and rendering, via one or more speakers and one or more amplifiers of the playback device, the one or more channels of the multi-channel audio content.

Another example is directed to a method of rendering multi-channel audio content via a bonded group of playback devices. In an example, the method comprises broadcasting, over a wireless network, a transmit audio stream comprising a first plurality of sequential frames of multi-channel audio content and a second plurality of sequential frames of the multi-channel audio content, the second plurality of sequential frames of the multi-channel audio content being time-delayed by one frame relative to the first plurality of sequential frames of the multi-channel audio content, and receiving at each of a plurality of playback devices in the bonded group, a respective received audio stream corresponding to the transmit audio stream. In an example, the method further comprises, for at least one playback device of the plurality of playback devices, determining that a particular frame of the audio data is missing from the second plurality of frames of the audio data in the respective received audio stream, and interpolating a representation of the missing frame based on a corresponding particular frame of the audio data in the first plurality of frames of the audio data in the received audio stream. In an example, the method further comprises, at each of the plurality of playback devices, constructing one or more respective channels of the multi-channel audio content based on the respective received audio stream, wherein, for the at least one playback device, the constructed one or more respective channels of the multi-channel audio content includes the representation of the missing frame, and rendering the one or more respective channels of the multi-channel audio content in synchrony with rendering of other channels of the multi-channel audio content by others of the plurality of playback devices in the bonded group.

### BRIEF DESCRIPTION OF THE DRAWINGS

Aspects, and advantages of the presently disclosed technology may be better understood with regard to the following description, appended claims, and accompanying drawings, as listed below. A person skilled in the relevant art will understand that the elements shown in the drawings are for purposes of illustrations, and variations, including different and/or additional elements and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2 is a block diagram of one example of a home theater environment according to aspects of the present disclosure.

FIG. 3 is a diagram illustrating one example of a transmission sequence according to aspects of the present disclosure.

FIG. 4 is a diagram illustrating another example of a transmission sequence according to aspects of the present disclosure.

FIG. 5 is a diagram illustrating an example of modulo (4) interleaving applied to audio data packets according to aspects of the present disclosure.

FIG. 6 is a diagram illustrating an example of modulo (4) interleaving according to aspects of the present disclosure.

FIGS. 7A-C are diagrams illustrating examples of RLNC techniques applied to audio data packets according to aspects of the present disclosure.

FIG. 8 is a diagram illustrating an example of a sub-sampling technique according to aspects of the present disclosure.

FIG. 9 is a diagram illustrating an example of an audio transmission and recovery technique according to aspects of the present disclosure.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to techniques for providing resilient, low-latency, multi-channel audio content in multi-player media environments, such as a home theater environment, for example. As described in more detail below, playback devices that are bonded may have different playback responsibilities, such as responsibilities for certain audio channels. For example, a home theater environment may include a display device, such as a television or monitor, that displays visual content and outputs audio content (associated with the displayed visual content) to a primary device (e.g., a soundbar, a smart TV box, a smart TV stick, etc.), which in turn communicates one or more audio channels of the audio content to one or more satellite playback devices via wireless communication links. In some instances, it may be desirable for the primary device and/or the satellite playback device(s) to render audio content in lip-synchrony with associated visual content displayed by the display device such that there is no perceived audio delay (i.e., no lip-syncing issues are perceived) by the viewer. In this regard, it can be shown that in some cases, a delay of no more than 40 milliseconds (ms) between the video content being rendered and the audio content being heard is imperceptible to the average viewer.

In certain home theater configurations, the primary device transmits data packets containing the audio data corresponding to one or more audio channels to each satellite playback device individually in a sequential or “round robin” fashion. Further, in certain configurations, the primary device waits for acknowledgment of receipt of each data packet from the respective satellite playback device before transmitting the next data packet to the next satellite playback device in the sequence. Unacknowledged packets may be re-transmitted, potentially several times, for the next packet is sent. This approach takes time, and the latency associated with the transmission increases as the number of satellite playback devices increases. Accordingly, the latency constraint imposed by the need to maintain lip synchrony with the corresponding video content may limit the number of audio channels and/or satellite playback devices that can be supported.

Accordingly, aspects and embodiments are directed to techniques for addressing these issues and providing the ability to support higher numbers of satellite playback devices and/or audio channels. As described further below, according to certain examples, the primary device can be configured to broadcast data packets containing data corresponding to multiple audio channels to multiple satellite playback devices at the same time. Respective individual satellite playback devices may then extract data corresponding to the one or more audio channels for which the respective satellite playback device is responsible. This approach reduces the number of times the communication medium is accessed and has lower latency than the sequential “unicast” transmission scheme described above. In some examples, data packets are continuously or periodically broadcast without waiting for acknowledgment of receipt from any of the satellite playback devices, thereby avoiding re-transmissions associated with the sequential approach described above. In addition, as described in more detail below, certain examples provide techniques for making the audio data transmitted more resilient to channel errors, including lost data packets. Further examples provide packet loss concealment techniques that can be implemented by the satellite playback devices to improve audio quality even in the presence of channel errors such as lost data packets.

In some embodiments, for example, a playback device (e.g., a primary device in a home theater or other bonded group) is configured to operate in a bonded group comprising the playback device and a plurality of satellite playback devices, wherein to operate in the bonded group comprises to divide a sample of multi-channel audio content into a plurality of frames of audio data, each frame of audio data comprising a first number of symbols of each audio channel of a plurality of audio channels of the multi-channel audio content, to decompose each frame of audio data into a number of interleaved packets, to produce an audio stream comprising the interleaved packets corresponding to one or more frames of the plurality of frames of audio data, and to broadcast the audio stream to the plurality of satellite playback devices via a wireless communication interface. In some examples, decomposing each frame of audio data into a number of interleaved packets is performed according to a modulo(k) approach applied to the first number of symbols, wherein k is the number of interleaved packets. As described further below, k can be fixed or variable. According to certain examples, a playback device (e.g., a satellite playback device) is configured to receive, via a wireless communication interface, an audio stream comprising one or more frames of audio data corresponding to multi-channel audio content, each frame including a plurality of interleaved packets of the audio data, and to store at least one frame of audio data in an audio sample buffer. The playback device may be further configured to, for each stored frame of audio data, de-interleave the plurality of interleaved packets to construct one or more channels of the multi-channel audio content, and render, via one or more speakers and one or more amplifiers that drive the one or more speakers, the one or more channels of the multi-channel audio content.

In further embodiments, for example, a playback device is configured to operate in a bonded group comprising the playback device and a plurality of satellite playback devices, wherein to operate in the bonded group comprises to construct a transmit audio stream comprising a first plurality of sequential frames of multi-channel audio content and a second plurality of sequential frames of the multi-channel audio content, the second plurality of sequential frames of the multi-channel audio content being time-delayed by one frame relative to the first plurality of sequential frames of the multi-channel audio content, and to broadcast the transmit audio stream to the plurality of satellite playback devices via the wireless communication interface.

According to another embodiment, a playback device can be configured to receive, via a wireless communication interface, a first plurality of frames of audio data corresponding to multi-channel audio content, store the first plurality of frames of the audio data in the audio sample buffer, receive, via the wireless communication interface, a second plurality of frames of the audio data, store the second plurality of frames of the audio data in the audio sample buffer, determine that a particular frame of the audio data is missing from the second plurality of frames of the audio data, interpolate a representation of the missing frame based on a corresponding particular frame of the audio data in the first plurality of frames of the audio data, construct one or more channels of the multi-channel audio content based on the second plurality of frames of the audio data and the representation of the missing frame, and render, via the one or more speakers and the one or more amplifiers, the one or more channels of the multi-channel audio content.

These and other examples, aspects, and techniques are described in more detail below.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

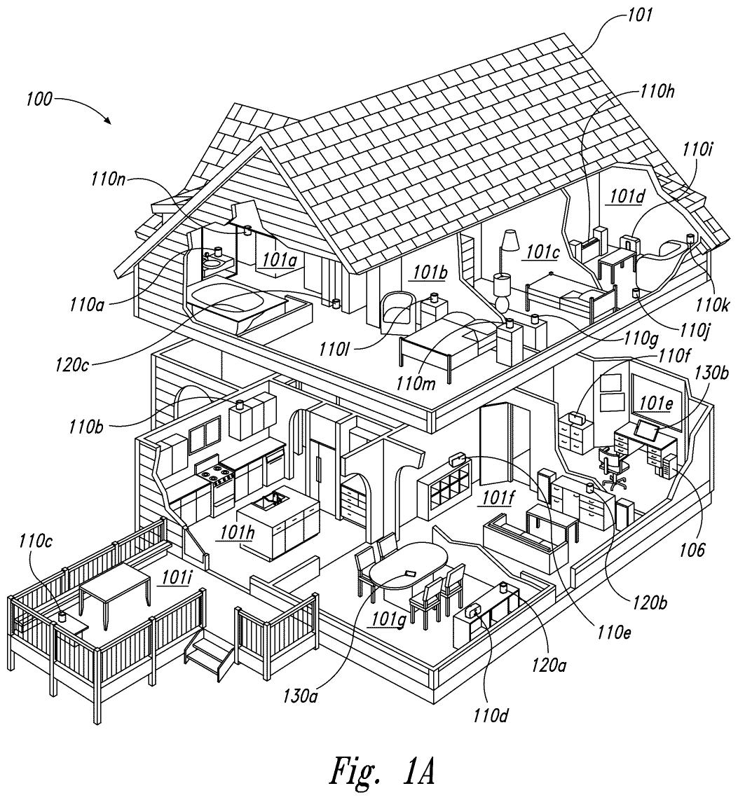

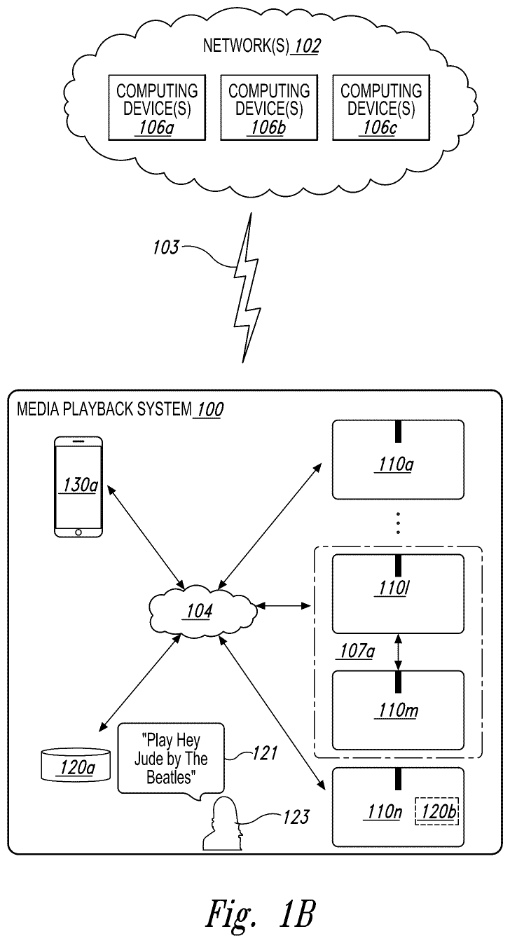

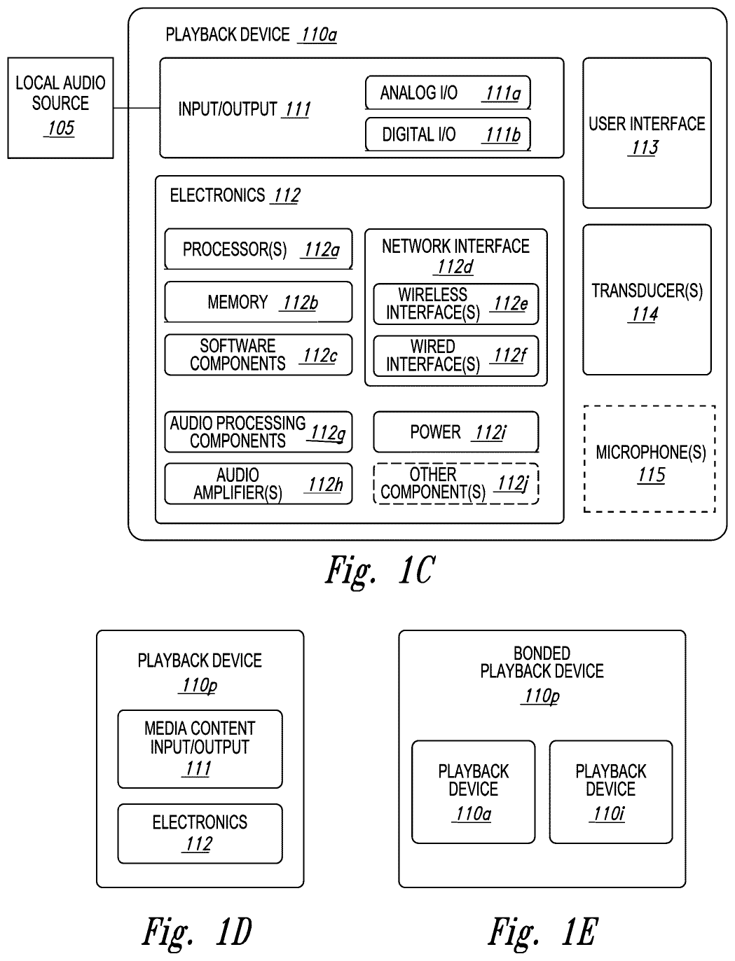

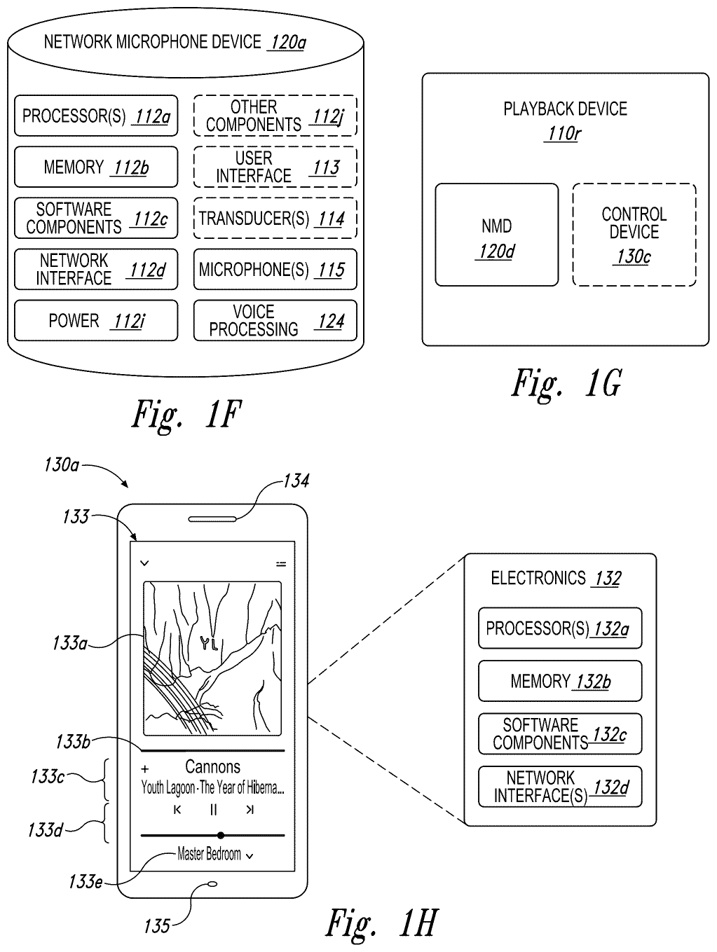

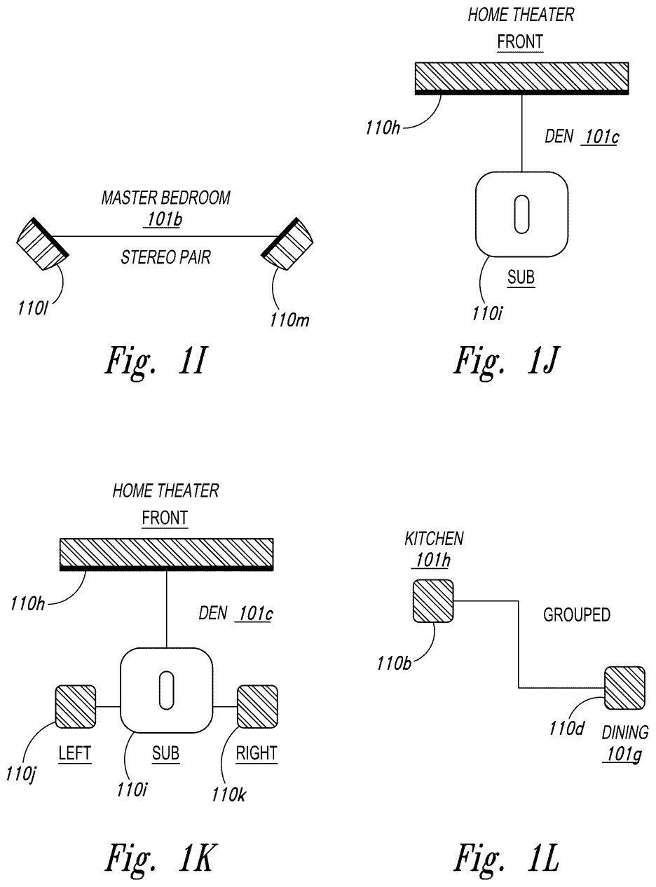

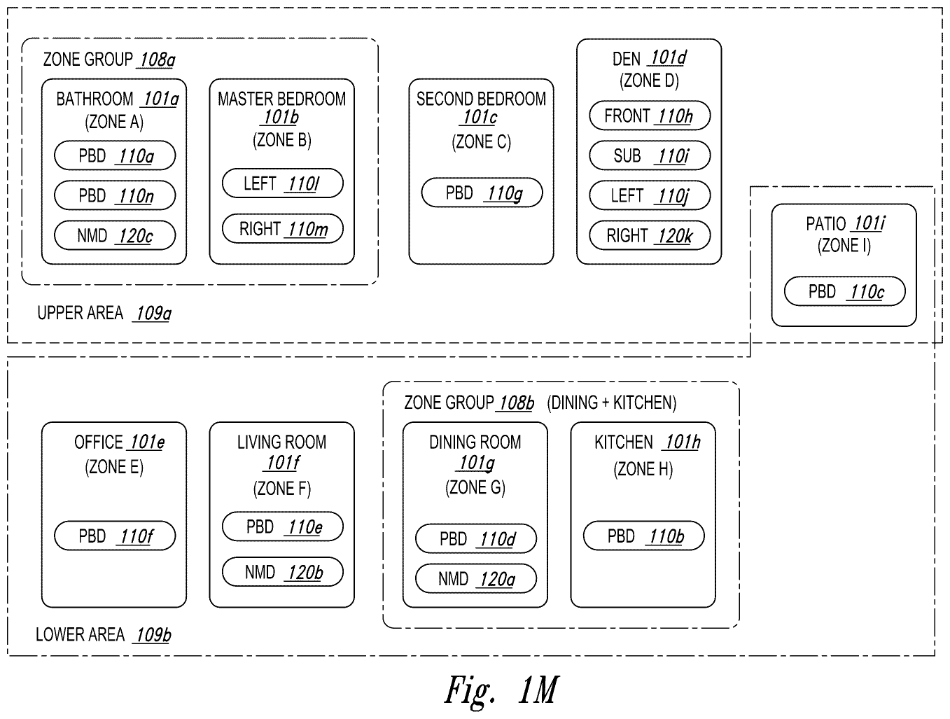

In the Figures, identical reference numbers identify generally similar, and/or identical, elements. To facilitate the discussion of any particular element, the most significant digit or digits of a reference number refers to the FIG. in which that element is first introduced. For example, element 110a is first introduced and discussed with reference to FIG. 1A. Many of the details, dimensions, angles, and other aspects shown in the FIGS. are merely illustrative of particular embodiments of the disclosed technology. Accordingly, other embodiments can have other details, dimensions, angles, and aspects without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-1M.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101c, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WIFI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WIFI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. II through IM.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as n LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which is incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WIFI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. ID is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. IF is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. IF, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other attributes, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1I through IM show example configurations of playback devices in zones and zone groups. Referring first to FIG. IM, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Right and Left devices 110j and 112k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110c, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in U.S. Pat. No. 10,499,146, which is hereby incorporated herein by reference in its entirety.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Techniques for Providing Low-Latency, Resilient Multi-Channel Audio Content

As described above, in some instances, playback devices that are bonded may have different playback responsibilities, such as responsibilities for certain audio channels. For example, as illustrated in FIG. 1K, in a home theater environment, the Front and SUB devices 110h and 110i can be bonded with Left and Right playback devices 110j and 110k, respectively. Further, in some implementations, the Right and Left devices 110j and 110k can be configured to form surround or “satellite” channels of a home theater system. The bonded playback devices 110h, 110i, 110j, and 110k may form a single Zone D (FIG. IM).

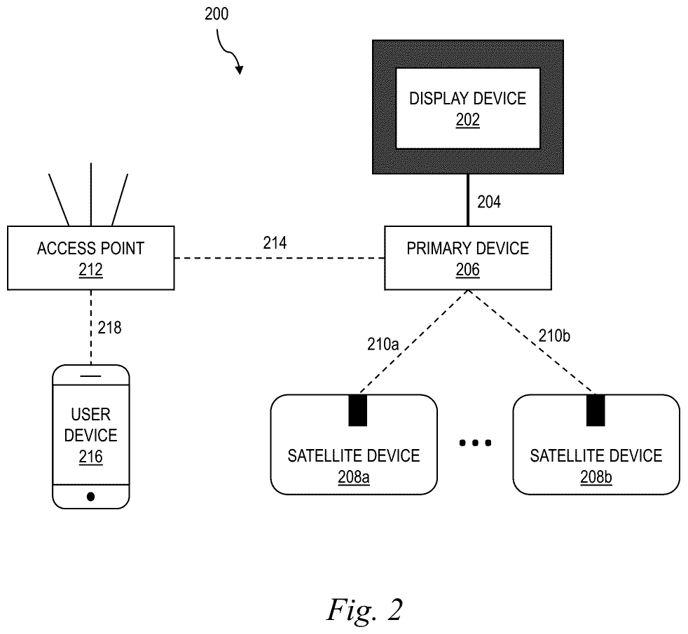

FIG. 2 illustrates an example of a home theater environment 200. As shown, the home theater environment 200 comprises a display device 202, such as a television or monitor, that displays visual content and outputs audio content (associated with the displayed visual content) via communication link 204 to a primary device 206 (e.g., a soundbar, a smart TV box, a smart TV stick, etc.). The primary device 206 communicates with one or more satellite devices 208 (shown as satellite devices 208a and 208b) via one or more communication links 210 (shown as communication links 210a and 210b). In certain examples, the communication links 210 correspond to one or more communication channels within a wireless network (e.g., a fronthaul connection) that is established for communication between the primary device 202 and the satellite devices 208. Additionally, the primary device 206 communicates with an access point (AP) 212 via a communication link 214 (e.g., a backhaul connection). The AP 212, in turn, communicates with other devices such as a user device 216 (e.g., a smartphone, tablet, laptop, desktop computer, etc.) via communication link 218. In some examples, the primary device 206 may be integrated with the display device 202. For example a TV may include a smart soundbar.

In some instances, the home theater environment 200 may play audio from a music streaming service. In such instances, the primary device 206 may communicate with one or more cloud servers associated with a music service provider (e.g., via the communication link 214 to the AP 212) to obtain the audio content for playback. After receipt of the audio content for playback, the primary device 206 may communicate the audio content (or any portion thereof) to the satellite devices 208 via the communication links 210 for synchronous playback. In examples where the primary device 206 is implemented as a soundbar (or otherwise comprises transducers for rendering audio content), the primary device 206 may render the audio content in synchrony with the satellite devices 208. In examples where the primary device 206 is implemented as a smart TV box or smart TV stick (or otherwise does not comprise transducers for rendering audio content), the satellite devices 208 may render the audio content in synchrony with each other while the primary device 206 may not render the audio content.

As described above, in some instances, the primary device 206 and the satellite devices 208 may render audio content in lip-synchrony with associated visual content displayed by the display device 202. In such examples, the primary device 206 may receive audio content from the display device 202. For example, the primary device 206 and the display device 202 can include analog and/or digital interfaces that facilitate communicating the audio content (e.g., multi-channel audio content) such as a SPDIF RCA interface, an HDMI interface (e.g., audio return channel (ARC) HDMI interface), an optical interface (e.g., TOSLINK interface), etc. In such examples, the communication link 204 may comprise a wired connection (e.g., an SPDIF cable, an HDMI cable, a TOSLINK cable, etc.). In other examples, the primary device 206 and the display device 202 may include wireless circuitry that facilitates wirelessly communicating the audio content from the display device 202 to the primary device 206. In such examples, the communication link 204 may be a wireless communication link such as a WIFI link, BLUETOOTH link, ZIGBEE link, Z-WAVE link, and/or wireless HDMI link.

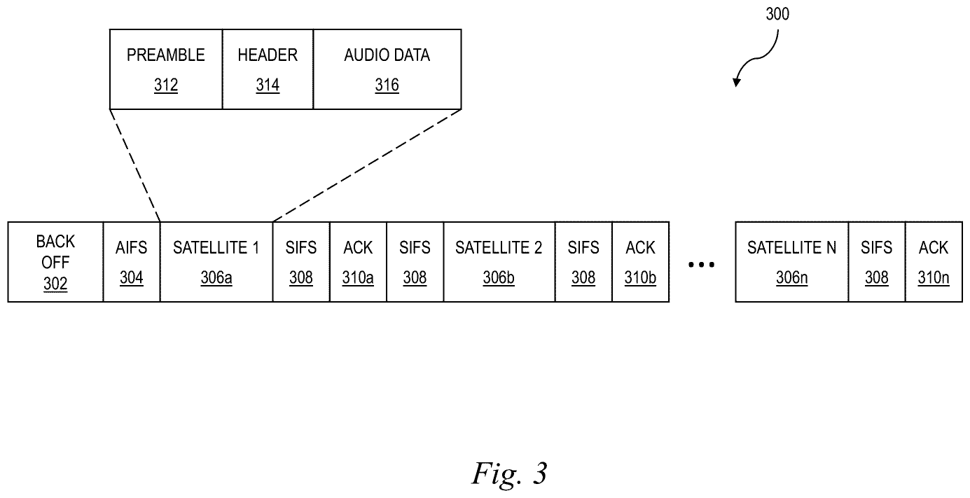

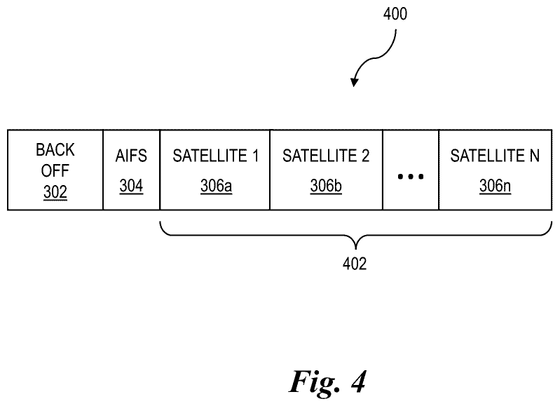

After receipt of the audio content associated with visual content to be rendered by the display device 202, the primary device 206 may communicate the received audio content (or any portion thereof) to the satellite devices 208 (e.g., via communication links 210). Any of a variety of methodologies may be employed to communicate the audio content to the satellite devices as described in more detail below with respect to FIGS. 3 and 4. Once the audio content has been communicated to the satellite devices 208, the satellite devices (and/or the primary device 206) may render the audio content in synchrony with each other and in lip-synchrony with visual content displayed on the display device 202. For instance, in examples where the primary device 206 is implemented as a soundbar (or otherwise comprises transducers for rendering audio content), the primary device 206 may render the audio content in synchrony with the satellite devices 208 and in lip-synchrony with the visual content displayed on the display device 202. In examples where the primary device 206 is implemented as a smart TV box or smart TV stick (or otherwise docs not comprise transducers for rendering audio content), the satellite devices 208 may render the audio content in synchrony with each other and in lip-synchrony with the display of visual content on the display device 202 while the primary device 206 may not render the audio content.

In certain examples, the primary device 206 can receive a stream of audio content samples from the display device 202. The audio content samples can be communicated from the display device 202 at any of a variety of rates including, for example, 44.1 kilohertz (kHz), 48 kHz, 96 kHz, 176.2 kHz, and 192 kHz. The audio content samples may comprise uncompressed audio content (e.g., Pulse-Code Modulation (PCM) audio) and/or compressed audio content (e.g., DOLBY audio such as DOLBY AC-3 audio, DOLBY E-AC-3 audio, DOLBY AC-4 audio, and DOLBY ATMOS audio). The display device 202 outputs the audio content samples while beginning the process of rendering the video content on a display (e.g., integrated into the display device 202). Given that the display device 202 may take tens of milliseconds to successfully render the video content, the audio content samples may be output just before the corresponding video content is displayed (e.g., tens of milliseconds earlier). The primary device 206 may coordinate playback of the audio content samples in lip-synchrony with the video content being displayed on the display device 202 such that there is no perceived audio delay (i.e., no lip-syncing issues are perceived) by the viewer. In this regard, it can be shown that in some cases, a delay of no more than 40 ms between the video content being rendered and the audio content being heard is imperceptible to the average viewer. The primary device 206 may achieve lip-synchrony by, for example, exploiting one or more of the following periods of time: (1) a gap between the display device 202 outputting the audio content samples and display device 202 actually displaying the associated visual content; and/or (2) an allowable delay between the visual content being displayed and the associated audio content being played back without losing lip-synchrony (e.g., up to 40 milliseconds).

As described above, in certain instances, the primary device 206 can utilize a “Round Robin” scheduling approach to “unicast” the audio content to the satellite devices 208 individually. The audio content is transmitted from the primary device 202 to the satellite devices 208 over a wireless communications channel or medium established in a wireless network over which the primary device 202 can communicate with the satellite devices 208 and vice versa. FIG. 3 illustrates an example of a communications medium utilization, or frame exchange, sequence corresponding to an example of a unicast audio data transmission approach.

At a start of a transmission sequence 300, a “back-off” segment (time interval) 302 is allocated to account for scheduling retransmission in the event of a collision in the medium (e.g., the medium is already occupied by transmissions from another source). The back-off interval 302 is followed by an arbitration interframe space (AIFS) interval 304. Interframe spaces are time intervals from the end of the last symbol of a previous transmission frame to the first symbol of a preamble of the next transmission frame in the air. Interframe spaces provide buffer time between frames to avoid interference, and can be used to control prioritization of any frame in the medium. The interframe spaces may also provide time intervals for processing a received frame of data and/or to allow a transceiver to switch between transmit and receive antennas, for example. The duration (length) of the AIFS interval 304 may vary depending on the communication protocol being used (e.g., a particular 802.11 standard), the carrier frequency of the wireless network (e.g., 2.4 GHz, 5 GHZ, 6 GHZ, etc.), and/or other factors. In some examples, the duration of the AIFS interval 304 may vary between about 28 microseconds (μs) and 150 μs.

After the AIFS interval 304, the primary device 206 may transmit an audio data segment 306a to a first satellite device 208. Transmission of the audio data segment 306a is followed by a Short Interframe Space (SIFS) interval 308. The primary device 206 then waits for acknowledgement of receipt of the audio data segment 306a by the first satellite device 208 during an acknowledgement interval 310a, which is in turn followed by another SIFS interval 308. The primary device 206 may then transmit a second audio data segment 306b to a second satellite device 208 and wait for acknowledgement of receipt of the audio data segment 306b by the second satellite device 208 during an acknowledgement interval 310b. The process can be repeated for each satellite device 208 in the bonded group.

The SIFS intervals 308 are described in IEEE transmission protocol standards and are used to “hold’ the communications medium for the duration of a frame exchange sequence (in this example, transmission of audio data segments 306 from the primary device 206 to a satellite device 208 and transmission of acknowledgment messages from the satellite device 208 to the primary device 206) to be completed. Using small “gaps” defined by the SIFS interval 308 between transmissions within the frame exchange sequence 300 prevents other devices, which are required by transmission protocol standards to wait for the medium to be idle for a longer time period than the SIFS interval 308, from attempting to access the medium, thus giving priority to completion of the frame exchange sequence in progress. The length/duration of the SIFS intervals 308 may be defined by the transmission protocol being used. For example, for an IEEE 802.11/b/g/n (2.4 GHZ) medium, the SIFS interval 308 may be 10 μs. For an IEEE 802.11a/n/ac (5 GHZ) medium, the SIFS interval 308 may be 16 μs.

As shown in FIG. 3, each audio data segment 306 may include a preamble 312, a header 314, and audio data 316 corresponding to one or more audio channels of multi-channel audio content to be rendered by the bonded group. In some examples, the preamble 312 and the header 314 have fixed durations. For example, the preamble 312 may have a duration of 40 μs and the header 314 may have a duration of 24 μs. However, in other examples, the preamble 312 and/or the header 314 may have other durations. The length of the audio data 316 may depend on the number of audio channels included and/or the resolution of the audio data. For example, higher resolution audio data may be described by a higher number of bits than lower resolution audio data and may thus consume more transmission time. Some satellite devices 208 may be responsible for rendering only a single audio channel of the multi-channel audio content, and therefore the audio data 316 for those satellite devices 208 may contain only the audio data corresponding to that single audio channel. Other satellite devices 208 may be capable of, and responsible for, rendering multiple audio channels of the multi-channel audio content, and therefore the audio data 316 for those satellite devices 208 may contain audio data corresponding to those multiple audio channels. Accordingly, the audio data 316 for different satellite devices 208 may have different lengths. In some examples, the audio data 316 may range in length from about 40 μs to about 232 μs.

As described above, to achieve playback of the multi-channel audio content in lip-synchrony with video content being displayed on the display device 202, it may be necessary to ensure that any delay (latency) between display of a sample of video content on the display device and playback of an associated audio sample by one or more of the satellite devices 208 and/or the primary device 206 does not exceed 40 ms. Accordingly, within the available time window, the primary device 206 may receive the sample of multi-channel audio content from the display device 202, decode the sample into the multiple audio channels assigned to each satellite device 208, execute an instance of the transmission sequence 300 to send the appropriate audio channel data to the satellite devices 208 (including receiving acknowledgement from each satellite device), an optionally prepare to render one or more audio channels of the multi-channel audio content. During the same available time window, each satellite device 208 may receive the audio data for the one or more audio channels for which it is responsible, acknowledge receipt to the primary device 208, and prepare the render the one or more audio channels.

As described above, and as is evident from FIG. 3, instances of the transmission sequence 300 increase in duration with increasing numbers of satellite devices 208. In addition, in certain examples, if the primary device 206 does not receive an acknowledgement message from a particular satellite device 208 during a respective acknowledgement interval 310, the primary device 206 may be configured to retransmit the respective audio data segment 306 before transmitting the next audio data segment. In some examples, the primary device 206 is configured to attempt multiple retransmissions, for example, up to 20 retransmissions, in the absence of the acknowledgement message before moving on to transmit the next audio data segment 306. This approach can add significant delay into completion of the transmission sequence 300. However, the latency requirements associated with a home theater environment (or other bonded group scenarios) may limit the maximum duration of the transmission sequence 300. Accordingly, when using the above-described unicast approach, the number of satellite devices 208 that can be included in the bonded group may be limited to only a few, for example, five or fewer satellite devices.

Techniques described herein provide an alternative communication approach in which the primary device 206 is configured to broadcast audio data corresponding to the multi-channel audio content to a group of satellite devices 208 simultaneously, rather than transmitting individual audio channel data to individual satellite devices 308 using the sequential unicast approach described above. The group of satellite devices 208 may include all satellite devices in the bonded group or a subset of the satellite devices in the bonded group. Each satellite device 208 may process the received audio data to extract the one or more audio channels for which that satellite device is responsible. This broadcast approach may consume less time than the sequential unicast approach described above and may be scalable to support a higher number of satellite devices 208 and/or audio channels while still meeting latency objectives associated with home theater environments.

In addition, certain embodiments provide techniques for improving the resiliency of the transmission sequence to losses or medium errors (e.g., lost data packets) such that the primary device 206 may not need to receive acknowledgement messages from the satellite devices 208 and retransmissions can be avoided. As described further below, according to certain examples, interleaving techniques can be applied to improve transmission resiliency. Removing the wait times associated with receiving acknowledgment messages and the delays associated with retransmissions can significantly reduce latency and allow an increase in the number of satellite devices and/or audio channels supported. For example, applying techniques disclosed herein may allow a home theater bonded group to support 15 satellite devices and 24 audio channels while still achieving a latency of less than 10 ms, well within the 40 ms margin for maintaining lip-synchrony with associated video content. In addition, as described further below, certain embodiments provide techniques for packet loss concealment on the satellite devices 208 for improved (better sounding) audio quality.

Referring to FIG. 4, there is illustrated an example of a transmission sequence 400 corresponding to an example broadcast transmission approach according to certain aspects. In this example, the transmission sequence 400 includes the back-off interval 302 and AIFS interval 304 described above, followed by an audio data portion 402. The audio data portion 402 includes a plurality of audio data segments 306 for the satellite devices 208. Although individual audio data segments 306a-n are illustrated in FIG. 4, the audio data portion 402 is a single continuous transmission that involves only a single access to the communications medium. Accordingly, SIFS intervals 308 are not required between the audio data segments 306. Each transmission sequence 400 may include one or more samples of multi-channel audio content that have been received from the display device 202 by the primary device 206 and prepared, by the primary device 206, for transmission to the satellite devices 208.

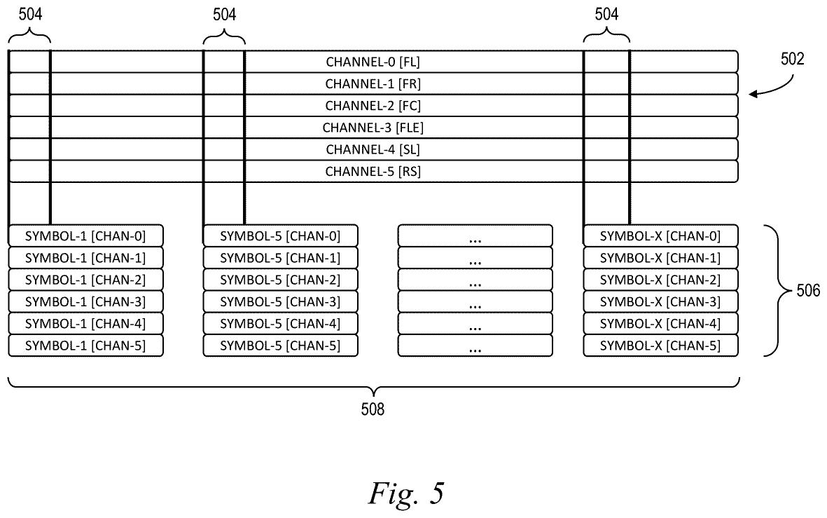

As discussed above, according to certain examples, a packet interleaving process can be applied to the data representing the multi-channel audio content to make the audio data portion 402 more resilient to conditions that may result in one or more packets of data being lost. Such conditions may include, for example, a noisy medium, and/or poor signal strength in the wireless communication link(s) 210. FIG. 5 illustrates an example of a modulo (4) interleaving process.

Referring to FIG. 5, a native packet 502 of audio data includes a plurality of audio channels (n audio channels, n being a positive integer), each audio channel being represented by m symbols 504 of data (m being a positive integer that may be the same as or different from n). Each symbol 504 is represented by a number of bits that may vary depending on the audio quality/resolution for a given frequency. The length/duration of the native packet 502 may depend on the audio quality (number of bits in each symbol) and the number of symbols 504 included in the packet. For example, the native packet 502 may include 2.9 ms or 5.8 ms of audio data containing n audio channels of 24-bit (symbols) audio quality at 48 KHz.

According to certain examples, in applying interleaving, an audio frame (native audio packet 502) is decomposed into a plurality of interleaved packets 506. To produce an interleaved packet 506, a subset of symbols 504 from the native packet 502 are selected using a modulo(k) approach, where k is the number of interleaved packets 506 to be produced from the native packet 502. In the example of FIG. 5, a modulo (4) interleaving process 508 is applied, which results in four interleaved packets being produced from the native packet 502, the first of which is illustrated in FIG. 5 (interleaved packet 506). Using this approach, the first interleaved packet 506 comprises every [modulo (4)=0] numbered symbol 504 in the sample. Thus, a shown in FIG. 5, the first interleaved packet 506 includes the first symbol (symbol-1) of each audio channel, the fifth symbol (symbol-5) of each audio channel, etc., up to the (n-3)th symbol (symbol-x) of each audio channel. Similarly, the second interleaved packet (not shown in FIG. 5) includes every [modulo (4)=1] symbol 504 in the sample. The third interleaved packet includes every [modulo (4)=2] symbol 504 from the native packet 502, and the fourth interleaved packet includes every [modulo (4)=3] symbol 504 from the native packet 502.

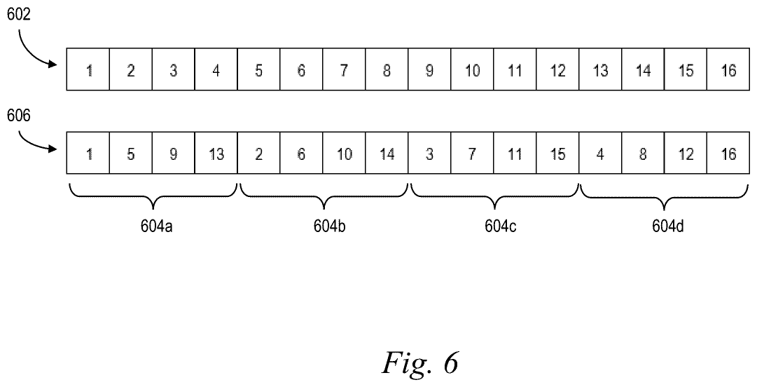

FIG. 6 illustrates an example of a modulo (4) interleaving process applied to a native packet 602 that includes 16 symbols. As shown, the 16 symbols are divided into four interleaved packets 604a-d, each including sequences of every fourth symbol, offset from one another by one symbol. The four interleaved packets 604a-d may be transmitted individually or may be concatenated into an interleaved packet sequence 606 for transmission.

Thus, referring again to FIG. 5, each native packet 502 of audio data can be reconstructed into a set of interleaved packets 506 that each contain a subset of the symbols present in the native packet 502. The number of symbols in each interleaved packet corresponds to the total number of symbols in the native packet 502 divided by the number of interleaved packets in the set. The interleaved packets 506 may then be transmitted in the audio data portion 402 to the satellite devices 208. Because each interleaved packet 506 contains only small, non-contiguous portions of the audio data associated with any given audio channel, a lost packet may have far less impact on the quality of the audio rendered by the satellite playback devices than loss of a native packet 502. Thus, using interleaving can make the audio data portion 402 far more resilient to packet loss issues that may be experienced in the communications medium.

The examples illustrated in FIGS. 5 and 6 use a modulo (4) interleaving approach. However, more generally, the primary device 206 may be configured to implement modulo(k) interleaving, where k is any positive integer number. Thus, in other examples, a modulo number (k) other than 4 may be used. In various examples, k can be selected based on any of several factors, including the total number of symbols 504 in each native packet 502 and/or a desired degree of separation between the symbols in each interleaved packet (e.g., packets containing every 3^{rd}, 4^{th}, 5^{th}, etc., symbol). In certain examples, k can be changed from one transmitted audio stream to another, optionally based on changing medium conditions and/or changing characteristics of the audio data (e.g., audio quality, number of symbols per native packet, etc.,).

After receiving the audio data portion 402, the satellite devices 208 may reconstruct the native packets 502 from the interleaved packets 506 based on a known value of k. In some examples in which k is fixed, the satellite devices may have a priori knowledge of the value of k. In other examples, k may be specified in the transmission, for example, in the preamble 312 or header 314. In some examples, each satellite device 208 may reconstruct the audio data for the one or more audio channels for which that satellite device has responsibility for rendering. In other examples, each satellite device 208 may reconstruct the complete frame(s) of audio data and then extract the audio data for the one or more audio channels for which that satellite device 208 has responsibility for rendering.

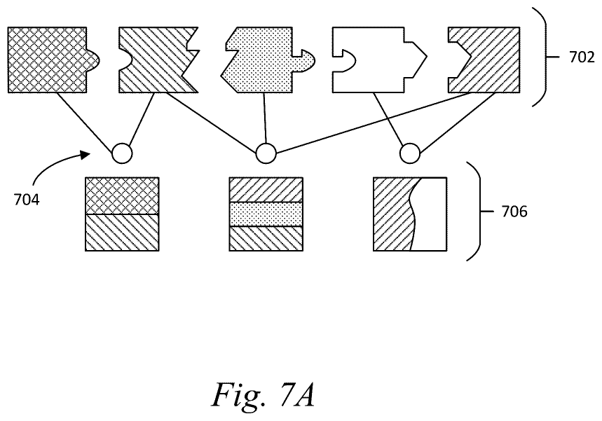

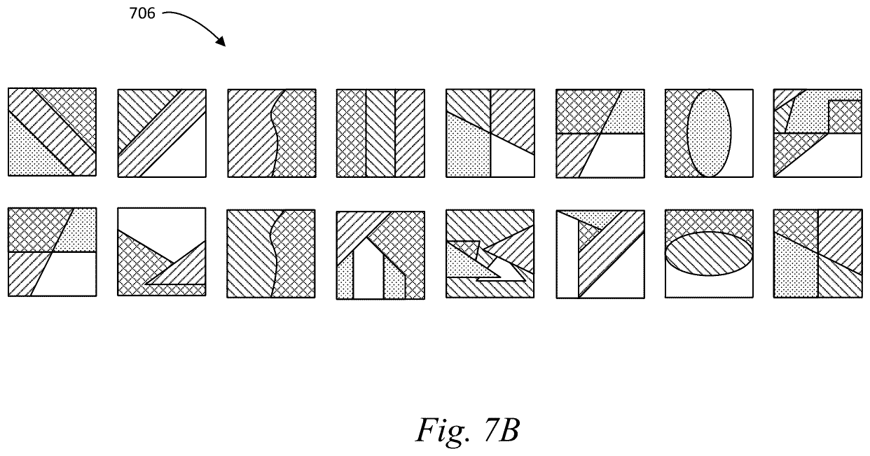

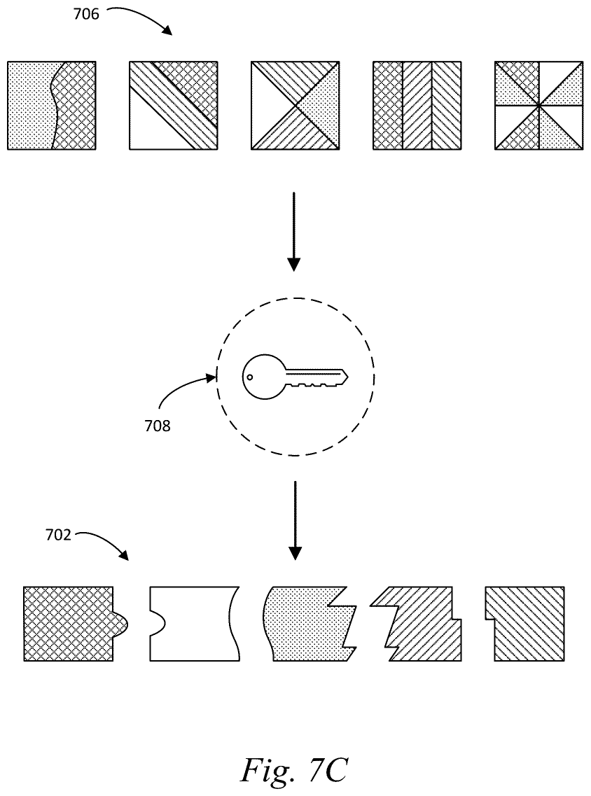

According to some embodiments, random linear network coding (RLNC) can be used instead of interleaving. FIGS. 7A-7C illustrate examples of applying RLNC to packets of audio data. Referring to FIG. 7A, RLNC is an encoding scheme in which native packets 702 are converted into encoded packets 706 by a set of “nodes” 704 using linear combinations of the symbols in the native packets 702. The primary device 206 may implement the set of nodes 704 to generate the encoded packets 706, which are linear combinations of the native packets 702, by multiplying the native packets 702 by coefficients chosen randomly, with a uniform distribution, from a finite Galois field.

According to one example, a group of P nodes 704 move the data contained in M native packets 702 to K encoded packets. Each node, pₙ, generates an encoded packet kₙ from the linear combination of a set of received native packets {mᵢ}ᵢ₌₁^{M}, according to the formula:

$${k}_{n} = {\sum }_{i = 1}^{M} {g}_{n}^{i} \cdot {m}_{i} \qquad ( F 1 )$$

The values, gₙⁱ, are the coefficients selected from the Galois field having a size 2^{M}. A wide variety of different encoded packets 706 may be produced, as illustrated in FIG. 7B, for example. In examples, since operations are computed in a finite field, each generated encoded packet 706 is of the same length as the original native packets 702. The encoded packets 706 may be transmitted to the satellite devices 208 in the audio data portion 402. After reception of the audio data portion 402, the satellite devices 208 may collect the K encoded packets 706 into a matrix. The original M native packets 702 may then be recovered by performing Gaussian elimination on the matrix. Once the native packets 702 have been recovered, each satellite device 208 can extract the audio channel data corresponding to the one or more audio channels for which that satellite device has responsibility for rendering, as described above.

There are several parameters considered when implementing RLNC. One parameter is the generation size, which corresponds to the number M of native packets 702 used for a particular transmission (“generation”). Another parameter is the packet size, or number of symbols included in each native packet 702. In some examples, the packet size of the native packets 702 is fixed. In the case of unequally-sized native packets 702, individual native packets can be zero-padded if shorter than a selected “standard” size, or split into multiple packets if longer than the standard size. Another parameter that can be considered is the size and type of the Galois field used. A common example of a Galois field is a binary extension field. Examples of the field size include a binary field GF(2) or a binary-8 field GF(2⁸). In a binary field, each element is one bit long, while in a binary-8 field, each element is one byte long. In some examples, each native packet 702 may have a size that is larger than the field size, such that each native packet may be viewed as a set of elements from the Galois field appended together.

Referring to FIG. 7C, in examples, the satellite devices 208 can reconstruct the native packets 702 from the received encoded packets 706 using a key 708. In some examples, the coding coefficients used to generate the encoded packets 706 are appended to the packets and included in the audio data portion 402 transmitted to the satellite devices. Therefore, each satellite device 208 can see what coefficients were used to generate each encoded packet 706. It should be noted that any satellite device 208 needs to collect a sufficient number of linearly independent encoded packets 706 to be able to reconstruct the original data. Each encoded packet 706 can be understood as a linear equation where the coefficients are known since they are appended to the packets. In these equations, each of the original M native packets is the unknown. Thus, to solve the linear system of equations, the satellite device 208 needs at least M linearly independent equations (encoded packets 706). Accordingly, in some examples the primary device 206 can be configured to produce the audio data portion 402 containing more than M linearly independent encoded packets 706 to reduce risk of degraded audio quality in the event of one or more lost packets during transmission of the sequence 400.

Thus, by applying interleaving or RLNC techniques as described above, the broadcast audio data portions 402 can be made more resilient to losses, thereby allowing the system to avoid or reduce the need for retransmissions and improve overall latency. In addition, as described above, interleaving may also contribute to concealing packet loss in the audio rendered by the satellite devices 208. As described above, because an interleaved packet 506 contains small, non-contiguous portions of the audio data corresponding to any audio channel of the multi-channel audio content, the loss of an interleaved packet during transmission to any satellite device 208 may be far less noticeable in the audio output rendered by the satellite device 208 than the loss of a native packet 702.

Certain aspects and embodiments provide further techniques for packet loss concealment and improvement of rendered audio quality even in the event of a lost packet. According to certain examples, the satellite devices 208 can be configured to apply interpolation processes to a received audio stream containing sets of interleaved packets 506 described above to compensate for any missing interleaved packets. In some examples, if one or more interleaved packets 506 are missing when a satellite device 208 performs the reconstruction process to recover the native packets 502, the satellite device may interpolate the missing interleaved data by using the received interleaved data around it. For example, if a modulo (4) interleaving approach was applied and if one of the four interleaved packets is not received, then only every fourth symbol has to be interpolated. In contrast, if a native packet 502 were lost, all symbols in the packet would need to be interpolated from adjacent packets. Thus, using interpolation based on interleaved packets may greatly enhance the resulting audio fidelity concealment. Audio concealment may be better between non-consecutively missing interleaved packets than consecutively missing interleaved packets, which may involve a higher level of interpolation. In some examples, the satellite device 208 stores the packets of the received audio stream in an audio sample buffer and performs the reconstruction, and optional interpolation process(es) on the packets stored in the audio sample buffer.

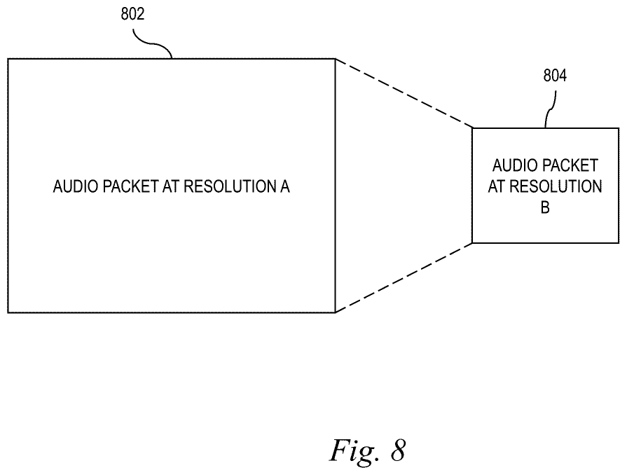

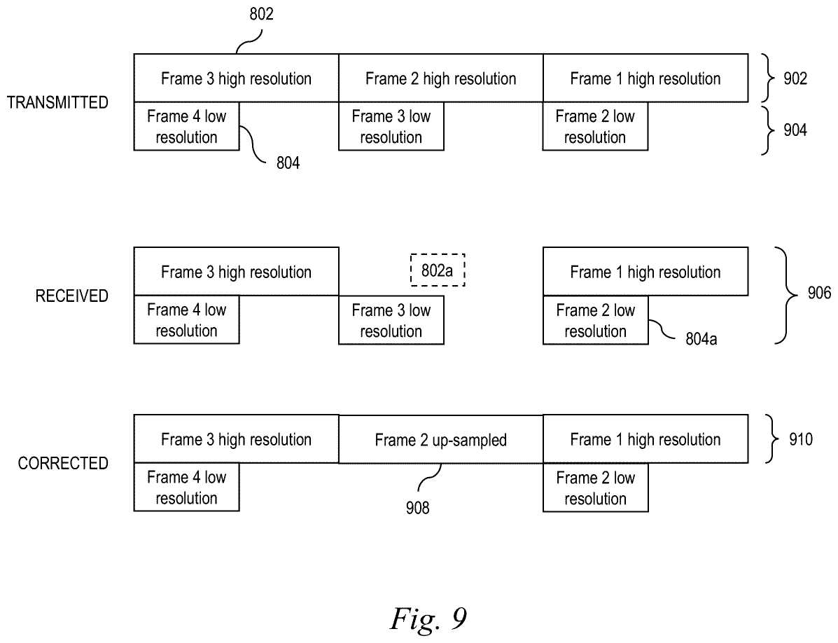

According to certain examples, sub-sampling techniques can be applied to create audio data recovery packets that can be used to mask the loss of one or more packets of audio data during transmission to any of the satellite devices 208. One example technique includes generating an additional representation of the audio data at a lower sampling rate. For example, referring to FIG. 8, for each “full-sampled” audio packet 802 having a first resolution (“A”), corresponding to a first sampling rate, an additional, sub-sampled, audio packet 804 can be produced having a second, lower resolution (“B”) that corresponds to a lower sampling rate than that used to produce the corresponding audio packet 802. For example, if the full-sampled audio packet 802 has 48 KHz resolution, the corresponding sub-sampled audio packet 804 may have 8 KHz resolution, meaning that it will be five times smaller than the audio packet 802. The sub-sampled audio packets 804 can be transmitted from the primary device 206 to the satellite devices 208 at a lower transmission rate than the transmission rate used to transmit the larger, full-sampled audio packets 802. The lower transmission rate may increase the probability that the sub-sampled audio packets 804 will be received by all the satellite devices 208. A satellite device 208 may then use the sub-sampled audio packet 804 as a recovery packet in the event that the satellite device does not receive the corresponding full-sampled audio packet 802. For example, within the playtime margin (which may be determined by a maximum latency limit set by conditions of the bonded group environment, such as the 40 ms latency limit to maintain lip-synchrony described above), the satellite device 208 may interpolate, or up-sample, the sub-sampled audio packet 804 (which may be stored in the audio sample buffer of the satellite device) to the sampling rate of the missing full-sampled audio packet 802 to produce a replacement packet that can be played in the resulting audio stream with reasonable audio quality. In this manner, the loss of the full-sampled audio packet 802 is concealed during audio playback by replacing it with the corresponding replacement packet. An example of this approach is illustrated in FIG. 9.

Referring to FIG. 9, in one example, the primary device 206 produces an audio stream for transmission (e.g., as the audio data portion 402 described above) that includes a first stream including a plurality of sequential full-sampled frames/packets 802 of multi-channel audio content and a second stream 904 including a plurality of sequential sub-sampled packets 804 of the multi-channel audio content. In the illustrated example, the plurality of full-sampled packets 802 are time-delayed by one frame relative to the plurality of sub-sampled frames 804. In other words, the satellite devices 208 may receive each sub-sampled packet 804 before they receive the corresponding full-sampled packet 802. This approach may be beneficial in that the satellite device 208 may already possess (e.g., stored in its audio sample buffer), the sub-sampled audio packet 804 that it may need to use to reconstruct a lost corresponding full-sampled packet 802, rather than having to wait to receive the sub-sampled packet 804 after determining that the corresponding full-sampled packet 802 is missing, which could increase latency.

It will be appreciated, given the benefit of this disclosure, that examples of interleaving or RLNC described above may be applied to the full-sampled audio packets 802 and/or to the sub-sampled audio packets 804.

As described above, according to certain examples, the second stream 904 of the sub-sampled audio packets 804 may be transmitted to the satellite devices 208 using a lower transmission rate than that used to transmit the first stream 902 of the full-sampled audio packets 802. Accordingly, there may be a higher probability that the satellite devices 208 receive all the sub-sampled audio packets 804, even if one or more full-sampled audio packets 802 are lost during transmission. For example, FIG. 9 illustrates such an occurrence where an audio data stream 906 received by at least one satellite device 208 is missing a full-sampled audio packet 802a, but includes the corresponding sub-sampled audio packet 804a. Accordingly, using the sub-sampled audio packet 802a (e.g., stored in the audio sample buffer), the satellite device 208 may reconstruct the missing full-sampled audio data packet 802. In some examples, the satellite device 208 up-samples the sub-sampled audio packet 804a to the sampling rate of the full-sampled audio packets 802 to produce a recovery packet 908. The recovery packet 908 can then be inserted into a corrected audio stream 910, as shown in FIG. 9, to replace the missing full-sampled audio packet 802a. The satellite device 208 may then extract the audio data corresponding to the one or more audio channels for which that satellite device is responsible from the corrected audio stream, and proceed to render the one or more audio channels as described above.

An aspect of value of the above-described approach is that only one additional sub-sampled audio packet 804 per full-sampled audio packet 802 may be broadcast to all the satellite devices, and this transmission may be made at the lowest base rate. This may increase the likelihood that the sub-sampled packet is received and can be up-sampled/interpolated to the full sampling rate of the audio data, e.g., 48 kHz (24-bit) in some examples, while having minimal impact on the system latency. If an audio stream sent without sub-sampling has noticeable audio dropouts due to missing packets, a system utilizing sub-sampling according to the techniques disclosed herein may have better audio quality under the same conditions.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular attribute, structure, or characteristic described in connection with the embodiment can be included in at least one example embodiment disclosed herein. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### V. Additional Examples

The following examples pertain to further embodiments, from which numerous permutations and configurations will be apparent.

Example 1 provides a playback device comprising a wireless communication interface configured to support communication of data via at least one network protocol, at least one processor, and at least one tangible non-transitory computer readable medium storing program instructions that are executable by the at least one processor to cause the playback device to operate in a bonded group comprising the playback device and a plurality of satellite playback devices, to operate in the bonded group comprising to receive a first audio stream including multi-channel audio content digitally encoded in a plurality of packets, each packet of the plurality including a first number of symbols of each of a plurality of audio channels of the multi-channel audio content, for each packet, produce a set of interleaved packets of the multi-channel audio content, each interleaved packet of the set including a proper subset of the first number of symbols, wherein a second number of symbols in the proper subset corresponds to the first number divided by a third number of interleaved packets in the set, produce a second audio stream comprising a plurality of the sets of interleaved packets of the multi-channel audio content, and broadcast the second audio stream to the plurality of satellite playback devices via the wireless communication interface.

Example 2 includes the playback device of Example 1, further comprising one or more speakers, and one or more amplifiers configured to drive the one or more speakers, wherein the at least one tangible non-transitory computer readable medium further stores program instructions that are executable by the at least one processor to cause the playback device, while operating in the bonded group, to render, via the one or more speakers and the one or more amplifiers, at least one audio channel of the multi-channel audio content in synchrony with rendering of a remainder of the plurality of audio channels by the plurality of satellite playback devices.

Example 3 includes the playback device of one of Examples 1 or 2, wherein the first and third numbers are configurable.

Example 4 includes the playback device of Example 3, wherein to produce the set of interleaved packets, the at least one tangible non-transitory computer readable medium further stores program instructions that are executable by the at least one processor to cause the playback device to select the third number based on one or more factors selected from a group including: a number of satellite playback devices in the bonded group, channel conditions of a wireless link established between the playback device and the plurality of playback devices for broadcast of the second audio stream, a number of the plurality of audio channels, or the first number.

Example 5 includes the playback device of any one of Examples 1-4, wherein the wireless communication interface comprises radio circuitry including a first radio and a second radio, and at least one antenna coupled to the radio circuitry, wherein the playback device is configured to receive the first audio stream using the first radio and to broadcast the second audio stream to the plurality of satellite playback devices using the second radio.

Example 6 includes the playback device of any one of Examples 1-5, wherein the playback device is a soundbar.

Example 7 includes the playback device of any one of Examples 1-6, wherein to broadcast the second audio stream comprises foregoing acknowledgment of receipt of any set of interleaved packets from the plurality of satellite playback devices.

Example 8 provides a playback device comprising a wireless communication interface configured to support communication of data via at least one network protocol, at least one processor, and at least one tangible non-transitory computer readable medium storing program instructions that are executable by the at least one processor to cause the playback device to operate in a bonded group comprising the playback device and a plurality of satellite playback devices. To operate in the bonded group comprises to divide a sample of multi-channel audio content into a plurality of frames of audio data, each frame of audio data comprising a first number of symbols of each audio channel of a plurality of audio channels of the multi-channel audio content, to decompose each frame of audio data into a number of interleaved packets according to a modulo(k) approach applied to the first number of symbols, wherein k is the number of interleaved packets, to produce an audio stream comprising the interleaved packets corresponding to one or more frames of the plurality of frames of audio data, and to broadcast the audio stream to the plurality of satellite playback devices via the wireless communication interface.

Example 9 includes the playback device of Example 8, wherein k is four.

Example 10 includes the playback device of Example 8, wherein k is configurable.

Example 11 includes the playback device of any one of Examples 8-10, wherein to decompose each frame of audio data into the number of interleaved packets, the at least one tangible non-transitory computer readable medium further stores program instructions that are executable by the at least one processor to cause the playback device to select k based on one or more factors selected from a group including: a number of satellite playback devices in the bonded group, channel conditions of a wireless link established between the playback device and the plurality of playback devices for broadcast of the audio stream, a number of the plurality of audio channels, or the first number.

Example 12 includes the playback device of any one of Examples 8-11, wherein the at least one tangible non-transitory computer readable medium further stores program instructions that are executable by the at least one processor to cause the playback device to receive, via the wireless communication interface, an input audio stream comprising the sample of multi-channel audio content.

Example 13 includes the playback device of Example 12, wherein the wireless communication interface comprises radio circuitry including a first radio and a second radio, and at least one antenna coupled to the radio circuitry, wherein the playback device is configured to receive the input audio stream using the first radio and to broadcast the audio stream to the plurality of satellite playback devices using the second radio.

Example 14 includes the playback device of any one of Examples 8-13, wherein the playback device is a soundbar.

Example 15 includes the playback device of any one of Examples 8-14, further comprising one or more speakers, and one or more amplifiers configured to drive the one or more speakers, wherein the at least one tangible non-transitory computer readable medium further stores program instructions that are executable by the at least one processor to cause the playback device, while operating in the bonded group, to render, via the one or more speakers and the one or more amplifiers, at least one audio channel of the multi-channel audio content in synchrony with rendering of a remainder of the plurality of audio channels by the plurality of satellite playback devices.

Example 16 includes the playback device of any one of Examples 8-14, wherein to broadcast the audio stream comprises foregoing acknowledgment of receipt of any of the interleaved packets from the plurality of satellite playback devices.

Example 17 provides a playback device comprising one or more speakers, one or more amplifiers configured to drive the one or more speakers, an audio sample buffer, a wireless communication interface configured to support communication of data via at least one network protocol, and at least one processor. The playback device further comprises at least one tangible non-transitory computer readable medium storing program instructions that are executable by the at least one processor to cause the playback device to receive, via the wireless communication interface, an audio stream comprising one or more frames of audio data corresponding to multi-channel audio content, each frame including a plurality of interleaved packets of the audio data, store at least one frame of audio data in the audio sample buffer, for each stored frame of audio data, de-interleave the plurality of interleaved packets to construct one or more channels of the multi-channel audio content, and render, via the one or more speakers and the one or more amplifiers, the one or more channels of the multi-channel audio content.

Example 18 includes the playback device of Example 17, wherein to de-interleave the plurality of interleaved packets, the least one tangible non-transitory computer readable medium further stores program instructions that are executable by the at least one processor to cause the playback device to de-interleave the plurality of interleaved packets based on a modulo-offset corresponding to a modulo(k) approach used to produce the plurality of interleaved packets, wherein k is a number of interleaved packets corresponding to a complete frame of the audio data.

Example 19 includes the playback device of one of Examples 17 or 18, wherein to construct the one or more channels of the multi-channel audio content, the least one tangible non-transitory computer readable medium further stores program instructions that are executable by the at least one processor to cause the playback device to identify the one or more channels of the multi-channel audio content from a plurality of channels of the multi-channel audio content present in the frame of audio data.

Example 20 includes the playback device of Example 19, wherein to construct the one or more channels of the multi-channel audio content, the non-transitory computer readable medium further stores program instructions that are executable by the at least one processor to cause the playback device to determine that at least one symbol of the one or more channels of multi-channel audio content is missing from the frame of audio data, and produce an estimate of the missing at least one symbol based on one or more symbols of the one or more channels of the multi-channel audio content present in the frame of audio data.

Example 21 includes the playback device of any one of Examples 17-20, wherein the one or more frames of audio data includes a first frame and a second frame, and wherein the non-transitory computer readable medium further stores program instructions that are executable by the at least one processor to cause the playback device to store the first and second frames of audio data in the audio sample buffer, determine that at least one symbol of the one or more channels of multi-channel audio content is missing from the first frame of audio data, and interpolate an estimate of the missing at least one symbol based on symbols of the one or more channels of the multi-channel audio content present in the second frame of audio data.

Example 22 includes the playback device of any one of Examples 17-21, wherein the playback device is a member of a bonded group comprising the playback device and a plurality of other playback devices, and wherein to render the one or more channels of the multi-channel audio content, the non-transitory computer readable medium further stores program instructions that are executable by the at least one processor to cause the playback device to render the one or more channels of the multi-channel audio content in synchrony with rendering of a plurality of other channels of the multi-channel audio content by the plurality of other playback devices.

Example 23 provides a playback device comprising one or more speakers, one or more amplifiers configured to drive the one or more speakers, an audio sample buffer, a wireless communication interface configured to support communication of data via at least one network protocol, and at least one processor. The playback device further comprises at least one tangible non-transitory computer readable medium storing program instructions that are executable by the at least one processor to cause the playback device to receive, via the wireless communication interface, a first plurality of frames of audio data corresponding to multi-channel audio content, store the first plurality of frames of the audio data in the audio sample buffer, receive, via the wireless communication interface, a second plurality of frames of the audio data, store the second plurality of frames of the audio data in the audio sample buffer, determine that a particular frame of the audio data is missing from the second plurality of frames of the audio data, interpolate a representation of the missing frame based on a corresponding particular frame of the audio data in the first plurality of frames of the audio data, construct one or more channels of the multi-channel audio content based on the second plurality of frames of the audio data and the representation of the missing frame, and render, via the one or more speakers and the one or more amplifiers, the one or more channels of the multi-channel audio content.

Example 24 includes the playback device of Example 23, wherein the second plurality of frames of the audio data are received after reception of the first plurality of frames of the audio data.

Example 25 includes the playback device of Example 23, wherein the second plurality of frames of the audio data are offset in time relative to the first plurality of frames of the audio data.

Example 26 includes the playback device of Example 25, wherein the second plurality of frames of the audio data are time-delayed by one frame relative to the first plurality of frames of the audio data.

Example 27 includes the playback device of any one of Examples 23-26, wherein the first plurality of frames of audio data have a first audio resolution, wherein the second plurality of frames of audio data have a second audio resolution higher than the first audio resolution, and wherein to interpolate the representation of the missing frame, the at least one tangible non-transitory computer readable medium stores program instructions that are executable by the at least one processor to cause the playback device to up-sample the corresponding particular frame of the audio data from the first plurality of frames of the audio data to produce the representation of the missing frame having the second audio resolution.

Example 28 includes the playback device of any one of Examples 23-27, wherein to construct the one or more channels of the multi-channel audio content, the least one tangible non-transitory computer readable medium further stores program instructions that are executable by the at least one processor to cause the playback device to identify the one or more channels of the multi-channel audio content from a plurality of channels of the multi-channel audio content present in the first and second pluralities of frames of the audio data.

Example 29 includes the playback device of any one of Examples 23-28, wherein the playback device is a member of a bonded group comprising the playback device and a plurality of other playback devices, and wherein to render the one or more channels of the multi-channel audio content, the non-transitory computer readable medium further stores program instructions that are executable by the at least one processor to cause the playback device to render the one or more channels of the multi-channel audio content in synchrony with rendering of a plurality of other channels of the multi-channel audio content by the plurality of other playback devices.

Example 30 includes the playback device of any one of Examples 23-29, wherein the wireless communication interface comprises an IEEE 802.11 based transceiver.

Example 31 provides a playback device comprising a wireless communication interface configured to support communication of data via at least one network protocol, at least one processor, and at least one tangible non-transitory computer readable medium storing program instructions that are executable by the at least one processor to cause the playback device to operate in a bonded group comprising the playback device and a plurality of satellite playback devices. In this example, to operate in the bonded group comprises to construct a transmit audio stream comprising a first plurality of sequential frames of multi-channel audio content and a second plurality of sequential frames of the multi-channel audio content, the second plurality of sequential frames of the multi-channel audio content being time-delayed by one frame relative to the first plurality of sequential frames of the multi-channel audio content, and broadcast the transmit audio stream to the plurality of satellite playback devices via the wireless communication interface.

Example 32 includes the playback device of Example 31, wherein the first plurality of sequential frames of the multi-channel audio content have a first audio resolution, and wherein the second plurality of sequential frames of the multi-channel audio content have a second audio resolution higher than the first audio resolution.

Example 33 includes the playback device of one of Examples 31 or 32, further comprising one or more speakers, and one or more amplifiers configured to drive the one or more speakers, wherein the at least one tangible non-transitory computer readable medium further stores program instructions that are executable by the at least one processor to cause the playback device, while operating in the bonded group, to render, via the one or more speakers and the one or more amplifiers, at least one audio channel of the multi-channel audio content in synchrony with rendering of a remainder of the plurality of audio channels by the plurality of satellite playback devices.

Example 34 includes the playback device of any one of Examples 31-33, wherein the at least one tangible non-transitory computer readable medium further stores program instructions that are executable by the at least one processor to cause the playback device to receive, via the wireless communication interface, an input audio stream comprising the multi-channel audio content.

Example 35 includes the playback device of Example 34, wherein the wireless communication interface comprises radio circuitry including a first radio and a second radio, and at least one antenna coupled to the radio circuitry, wherein the at least one tangible non-transitory computer readable medium further stores program instructions that are executable by the at least one processor to cause the playback device to receive the input audio stream using the first radio, and to broadcast the transmit audio stream to the plurality of satellite playback devices using the second radio.

Example 36 includes the playback device of any one of Examples 31-35, wherein the playback device is a soundbar.

Example 37 provides a method of generating audio with a playback device, the method comprising receiving, at the playback device, a first plurality of frames of audio data corresponding to multi-channel audio content, storing the first plurality of frames of the audio data in an audio sample buffer of the playback device, receiving, at the playback device, a second plurality of frames of the audio data, storing the second plurality of frames of the audio data in the audio sample buffer, determining that a particular frame of the audio data is missing from the second plurality of frames of the audio data, interpolating a representation of the missing frame based on a corresponding particular frame of the audio data in the first plurality of frames of the audio data, constructing one or more channels of the multi-channel audio content based on the second plurality of frames of the audio data and the representation of the missing frame, and rendering, via one or more speakers and one or more amplifiers of the playback device, the one or more channels of the multi-channel audio content.

Example 38 includes the method of Example 37, wherein receiving the second plurality of frames of the audio data occurs after reception of the first plurality of frames of the audio data.

Example 39 includes the method of Example 37, wherein the second plurality of frames of the audio data are offset in time relative to the first plurality of frames of the audio data.

Example 40 includes the method of Example 39, wherein the second plurality of frames of the audio data are time-delayed by one frame relative to the first plurality of frames of the audio data.

Example 41 includes the method of any one of Examples 37-40, wherein the first plurality of frames of audio data have a first audio resolution, and wherein the second plurality of frames of the audio data have a second audio resolution higher than the first audio resolution.

Example 42 includes the method of Example 41, wherein interpolating the representation of the missing frame includes up-sampling the corresponding particular frame of the audio data from the first plurality of frames of the audio data to produce the representation of the missing frame having the second audio resolution.

Example 43 includes the method of any one of Examples 37-42, wherein constructing the one or more channels of the multi-channel audio content includes identifying the one or more channels of the multi-channel audio content from a plurality of channels of the multi-channel audio content present in the first and second pluralities of frames of the audio data.

Example 44 includes the method of any one of Examples 37-43, wherein the playback device is a member of a bonded group comprising the playback device and a plurality of other playback devices, and wherein rendering the one or more channels of the multi-channel audio content includes rendering the one or more channels of the multi-channel audio content in synchrony with rendering of a plurality of other channels of the multi-channel audio content by the plurality of other playback devices.

Example 45 provides one or more playback devices configured to implement the method of any one of Examples 37-44.

Example 46 provides a method of rendering multi-channel audio content via a bonded group of playback devices, the method comprising broadcasting, over a wireless network, a transmit audio stream comprising a first plurality of sequential frames of multi-channel audio content and a second plurality of sequential frames of the multi-channel audio content, the second plurality of sequential frames of the multi-channel audio content being time-delayed by one frame relative to the first plurality of sequential frames of the multi-channel audio content, receiving at each of a plurality of playback devices in the bonded group, a respective received audio stream corresponding to the transmit audio stream, for at least one playback device of the plurality of playback devices, determining that a particular frame of the audio data is missing from the second plurality of frames of the audio data in the respective received audio stream, and interpolating a representation of the missing frame based on a corresponding particular frame of the audio data in the first plurality of frames of the audio data in the received audio stream. The method further comprises, at each of the plurality of playback devices, constructing one or more respective channels of the multi-channel audio content based on the respective received audio stream, wherein, for the at least one playback device, the constructed one or more respective channels of the multi-channel audio content includes the representation of the missing frame, and rendering the one or more respective channels of the multi-channel audio content in synchrony with rendering of other channels of the multi-channel audio content by others of the plurality of playback devices in the bonded group.

Example 47 includes the method of Example 46, wherein the first plurality of sequential frames of the multi-channel audio content have a first audio resolution, and wherein the second plurality of sequential frames of the multi-channel audio content have a second audio resolution higher than the first audio resolution.

Example 48 includes the method of one Example 47, wherein interpolating the representation of the missing frame includes up-sampling the corresponding particular frame of the audio data from the first plurality of frames of the audio data to produce the representation of the missing frame having the second audio resolution.

Example 49 includes the method of any one of Examples 46-48, wherein constructing the one or more respective channels of the multi-channel audio content includes identifying the one or more channels of the multi-channel audio content from a plurality of channels of the multi-channel audio content present in the received audio stream.

Example 50 includes a media playback system comprising the bonded group of playback devices and configured to implement the method of any one of Examples 46-49.

1. A playback device comprising:
a wireless communication interface configured to support communication of data via at least one network protocol;
at least one processor; and
at least one tangible non-transitory computer readable medium storing program instructions that are executable by the at least one processor to cause the playback device to operate in a bonded group comprising the playback device and a plurality of satellite playback devices, to operate in the bonded group comprising to
receive a first audio stream including multi-channel audio content digitally encoded in a plurality of packets, each packet of the plurality including a first number of symbols of each of a plurality of audio channels of the multi-channel audio content,
for each packet, produce a set of interleaved packets of the multi-channel audio content, each interleaved packet of the set including a proper subset of the first number of symbols, wherein a second number of symbols in the proper subset corresponds to the first number divided by a third number of interleaved packets in the set,
produce a second audio stream comprising a plurality of the sets of interleaved packets of the multi-channel audio content, and
broadcast the second audio stream to the plurality of satellite playback devices via the wireless communication interface.

2. The playback device of claim 1, further comprising:
one or more speakers; and
one or more amplifiers configured to drive the one or more speakers;
wherein the at least one tangible non-transitory computer readable medium further stores program instructions that are executable by the at least one processor to cause the playback device, while operating in the bonded group, to render, via the one or more speakers and the one or more amplifiers, at least one audio channel of the multi-channel audio content in synchrony with rendering of a remainder of the plurality of audio channels by the plurality of satellite playback devices.

3. The playback device of claim 1, wherein to produce the set of interleaved packets, the at least one tangible non-transitory computer readable medium further stores program instructions that are executable by the at least one processor to cause the playback device to select the third number based on one or more factors selected from a group including: a number of satellite playback devices in the bonded group, channel conditions of a wireless link established between the playback device and the plurality of playback devices for broadcast of the second audio stream, a number of the plurality of audio channels, or the first number.

4. The playback device of claim 1, wherein the wireless communication interface comprises:
radio circuitry including a first radio and a second radio; and
at least one antenna coupled to the radio circuitry,
wherein the playback device is configured to receive the first audio stream using the first radio and to broadcast the second audio stream to the plurality of satellite playback devices using the second radio.

5. The playback device of claim 4, wherein the playback device is a soundbar.

6. The playback device of claim 1, wherein to broadcast the second audio stream to the plurality of satellite playback devices comprises to forego acknowledgment of receipt of the set of interleaved packets from the plurality of satellite playback devices.

7. A playback device comprising:
a wireless communication interface configured to support communication of data via at least one network protocol;
at least one processor; and
at least one tangible non-transitory computer readable medium storing program instructions that are executable by the at least one processor to cause the playback device to operate in a bonded group comprising the playback device and a plurality of satellite playback devices, to operate in the bonded group comprising to
divide a sample of multi-channel audio content into a plurality of frames of audio data, each frame of audio data comprising a first number of symbols of each audio channel of a plurality of audio channels of the multi-channel audio content,
decompose each frame of audio data into a number of interleaved packets according to a modulo(k) approach applied to the first number of symbols, wherein k is the number of interleaved packets,
produce an audio stream comprising the interleaved packets corresponding to one or more frames of the plurality of frames of audio data, and
broadcast the audio stream to the plurality of satellite playback devices via the wireless communication interface.

8. The playback device of claim 7, wherein k is four.

9. The playback device of claim 7, wherein to decompose each frame of audio data into the number of interleaved packets, the at least one tangible non-transitory computer readable medium further stores program instructions that are executable by the at least one processor to cause the playback device to select k based on one or more factors selected from a group including: a number of satellite playback devices in the bonded group, channel conditions of a wireless link established between the playback device and the plurality of playback devices for broadcast of the audio stream, a number of the plurality of audio channels, or the first number.

10. The playback device of claim 7, wherein the at least one tangible non-transitory computer readable medium further stores program instructions that are executable by the at least one processor to cause the playback device to receive, via the wireless communication interface, an input audio stream comprising the sample of multi-channel audio content.

11. The playback device of claim 10, wherein the wireless communication interface comprises:
radio circuitry including a first radio and a second radio; and
at least one antenna coupled to the radio circuitry,
wherein the playback device is configured to receive the input audio stream using the first radio and to broadcast the audio stream to the plurality of satellite playback devices using the second radio.

12. The playback device of claim 11, wherein the playback device is a soundbar.

13. The playback device of claim 7, further comprising:
one or more speakers; and
one or more amplifiers configured to drive the one or more speakers;
wherein the at least one tangible non-transitory computer readable medium further stores program instructions that are executable by the at least one processor to cause the playback device, while operating in the bonded group, to render, via the one or more speakers and the one or more amplifiers, at least one audio channel of the multi-channel audio content in synchrony with rendering of a remainder of the plurality of audio channels by the plurality of satellite playback devices.

14. The playback device of claim 7, wherein k is configurable.

15. A playback device comprising:
one or more speakers;
one or more amplifiers configured to drive the one or more speakers;
an audio sample buffer;
a wireless communication interface configured to support communication of data via at least one network protocol;
at least one processor; and
at least one tangible non-transitory computer readable medium storing program instructions that are executable by the at least one processor to cause the playback device to
receive, via the wireless communication interface, an audio stream comprising one or more frames of audio data corresponding to multi-channel audio content, each frame including a plurality of interleaved packets of the audio data,
store at least one frame of audio data in the audio sample buffer,
for each stored frame of audio data, de-interleave the plurality of interleaved packets to construct one or more channels of the multi-channel audio content, and
render, via the one or more speakers and the one or more amplifiers, the one or more channels of the multi-channel audio content.

16. The playback device of claim 15, wherein to construct the one or more channels of the multi-channel audio content, the least one tangible non-transitory computer readable medium further stores program instructions that are executable by the at least one processor to cause the playback device to:
identify the one or more channels of the multi-channel audio content from a plurality of channels of the multi-channel audio content present in the frame of audio data.

17. The playback device of claim 16, wherein to construct the one or more channels of the multi-channel audio content, the non-transitory computer readable medium further stores program instructions that are executable by the at least one processor to cause the playback device to:
determine that at least one symbol of the one or more channels of multi-channel audio content is missing from the frame of audio data; and
produce an estimate of the missing at least one symbol based on one or more symbols of the one or more channels of the multi-channel audio content present in the frame of audio data.

18. The playback device of claim 15, wherein the one or more frames of audio data includes a first frame and a second frame; and
wherein the non-transitory computer readable medium further stores program instructions that are executable by the at least one processor to cause the playback device to
store the first and second frames of audio data in the audio sample buffer;
determine that at least one symbol of the one or more channels of multi-channel audio content is missing from the first frame of audio data; and
interpolate an estimate of the missing at least one symbol based on symbols of the one or more channels of the multi-channel audio content present in the second frame of audio data.

19. The playback device of claim 15, wherein the playback device is a member of a bonded group comprising the playback device and a plurality of other playback devices; and
wherein to render the one or more channels of the multi-channel audio content, the non-transitory computer readable medium further stores program instructions that are executable by the at least one processor to cause the playback device to render the one or more channels of the multi-channel audio content in synchrony with rendering of a plurality of other channels of the multi-channel audio content by the plurality of other playback devices.

20. The playback device of claim 15, wherein to de-interleave the plurality of interleaved packets, the least one tangible non-transitory computer readable medium further stores program instructions that are executable by the at least one processor to cause the playback device to de-interleave the plurality of interleaved packets based on a modulo-offset corresponding to a modulo(k) approach used to produce the plurality of interleaved packets, wherein k is a number of interleaved packets corresponding to a complete frame of the audio data.
